(19) United States
(12) Patent Application Publication
(10) Pub. No.: US 2012/0091115 A1
(43) Pub. Date: Apr. 19, 2012

(54) ULTRA POWER SUPPLY

(76) Inventors: Sergei Y. Mironichev, Moscow (RU); Christopher D. Mechling, San Diego, CA (US)

(21) Appl. No.: 13/087,931

(22) Filed: Apr. 15, 2011

Related U.S. Application Data
(60) Provisional application No. 61/324,565, filed on Apr. 15, 2010.

(51) Int. Cl. H05B 3/02; H05B 1/00; H02J 7/00

(52) U.S. Cl. 219/211; 320/134

(57) ABSTRACT

An improved portable battery system having a plurality of accumulator batteries designed with circuit features to prolong life through cell balancing is disclosed. Further, the portable battery system is designed to be a lighter-weight alternative by use of individual field operators, for example, in colder climates configured to a heated garment. Additionally, the power supply includes a microcontroller that provides control and monitoring of accumulator properties. A power supply commutator is provided to aid efficient discharge of accumulators.

### PRIORITY CLAIM

This patent application contains subject matter claiming benefit of the priority date of U.S. Provisional Patent Application Ser. No. 61/324,565 filed on Apr. 15, 2010 and entitled, ULTRA POWER SUPPLY, accordingly, the entire contents of this provisional patent application is hereby expressly incorporated by reference.

### BACKGROUND OF THE INVENTION

1. Field of the Invention

The present invention relates generally to rechargeable electrical storage devices and battery powered loads. More particularly, in a preferred embodiment, the present invention pertains to an advanced rechargeable power supply system that can monitor and manage a plurality of individual accumulator power supplies that further include a plurality of individual load channels; the preferred embodiment further supplies power to heating element(s).

2. Description of the Art

Conventional electrical power supply circuits for portable devices have been known in the art. Some simple examples are applicable to flashlights and portable radios with more recent advanced examples comprising cellular telephones and portable power tools. Such circuits are designed with varying electrochemical cell capacities and varying load requirements.

One particular example was awarded patent protection in 2007 was proposed by Bedard et al., entitled “Compact Power Supply,” U.S. Pat. No. 7,230,352. According to Bedard, cells may be constructed from a variety of materials and configurations, each of which has a particular set of operating characteristics. For example, some constructions may be particularly well suited for supplying current at a consistent voltage over an extended period but unsuitable for high transient loads, whereas others are better suited for various changing loads. It is usual to select a cell construction best suited to a duty cycle to which it will be subjected. A duty cycle is defined as a proportion of time that a device or component is turned on against off time.

In many applications the duty cycle is consistent and repetitive allowing a particular cell construction to be used to satisfy the demands. In other applications, the duty cycle may vary dramatically and inconsistently making cell selection more difficult. To further complicate the selection, many applications that require high peak currents also have volume and weight constraints, for example power tools, hobby planes and race carts to name a few. A particular demanding application addressed by Bedard is a powered leg prosthesis where a battery is needed to power an actuator and move the user. For many of those applications that have high peak current requirements, the number of batteries required to satisfy the maximum peak current would not fit inside the available volume. Thus, Bedard devised a solution that includes a compact power supply that can meet varying demands and deliver high quantities of energy within a short amount of time, and fit inside a very limited volume.

Bedard's design generally comprises a battery storage element and associated circuitry that can better handle transient loads. More specifically, it employs a super capacitor to handle peak transient loads in addition to a shunt controller. U.S. Pat. No. 6,373,152, entitled “Electrical Energy Storage Device,” to Wang el al. proposes a similar design having similar objectives in mind.

An invention proposed by Richmond, U.S. Pub. Pat. App. No. 2009/0289046, entitled “Heated Garment,” specifically relates to a battery pack designed for seasonal use in a heated garment. The main point of novelty (presumed) lies in a control circuit that comprises a switch to open circuit preventing power drain during long periods of seasonal non-use. The switch makes it impossible to charge or discharge the battery cells during the extended non-use.

In similar fashion, the present invention seeks to provide a portable power supply to garments and/or wetsuits with circuits and components configured to maximize capacity with a fixed number of battery cells. It is a further object of the present invention to provide a battery system coupled to multiple heating elements that allows a user to individually set temperature for each heating element. It is an additional object of the present invention to provide a battery system with various controls further configured to an Rf remote control device. It is still further an object of the present invention to provide a battery system that can provide varied power with minimal loss using PWM (Pulse Width Modulation) current control. It is also an object of the present invention to provide protection and/or correction in an under or over voltage situation. It is yet still further an object of the present invention to provide a battery system configured to allow full individual charging and discharging of each cell improving reliability and endurance, as well as many other beneficial design characteristics.

### BRIEF SUMMARY OF THE INVENTION

The present invention specifically addresses and alleviates the above mentioned deficiencies associated with the prior art. More particularly, the present invention in a first aspect, is a portable power supply comprising: a plurality of accumulator battery cells for providing power to a load via a main circuit; a charging circuit coupled to the plurality of accumulator batteries, the charging circuit separate from the main circuit supplying power to the load; a power supply commutator for optimally supplying varied amounts of power to the load as needed; and a microcontroller for proving programmable control of the supplying varied amount of power via the power supply commutator.

The portable power supply in this aspect is additionally characterized wherein the plurality of accumulator batteries each comprises a corresponding up/down voltage converter to assist in cell balancing of the power supply. Also the load herein can be additionally characterized as being four heating elements. Additionally, the plurality of accumulator battery cells comprises eight cells and the power supply has four channels providing power to the four heating elements further configured to clothing for outdoor field operators in colder climates.

The portable power supply in this aspect is additionally characterized in that each of the plurality of cells comprises instrumentation, the instrumentation for monitoring for over temperature, charge relative to fully charged, over voltage, under voltage or under current. Also in the preferred embodiment, the microcontroller comprises a radio transceiver for remote command and control of the portable power supply. Also importantly for determining heating element temperature, the power supply has at least one power channel wherein the power channel comprises a resistive circuit wherein the resistive circuit has a fixed resistance and a variable resistance. Further a total resistance varies linearly with a temperature of a heating element and wherein the temperature of the heating element can be calculated based on the variable resistance at any given time.

The portable power supply in this aspect is further characterized wherein the microcontroller provides indication of a heating element temperature, the heating element temperature corresponding to a built-in heated garment device temperature, and wherein the microcontroller further provides indication for a power supply charge capacity relative to fully charged.

Importantly, the portable power supply herein also has a curved shape in a top aspect, the curved shaped providing a wearable power supply for heated garments; and a plurality of vias connecting a plurality of printed circuit board layers, the vias providing electrical conduction between the plurality of printed circuit board layers in addition to providing structural support to the portable power supply, the vias further arranged as a cage assembly with respect to the plurality of accumulator battery cells, the cage assembly around an outer periphery of the plurality of printed circuit board layers.

In a second aspect, the invention may be characterized as a heated garment comprising: a plurality of heating elements configured to the garment; a plurality of accumulator battery cells for providing power to the plurality of heating elements via a main circuit; and a top printed circuit board (PCB) layer electrically connected to the plurality of accumulator battery cells, the top printed circuit board having a curved shape, and forming a battery pack, the battery pack comprising a curved shape in a top aspect and further configured to the garment proving a wearable power supply.

The heated garment in this aspect is additionally characterized wherein the plurality of heating elements comprises four heating elements, and wherein the plurality of accumulator battery cells comprises eight cells and wherein the power supply comprises four channels providing power to the four heating elements configured to clothing for outdoor users in colder climates.

The heated garment is further characterized wherein the battery pack has a second PCB layer having a curved shape; a third PCB layer having a curved shape; and a bottom PCB layer opposite the top PCB layer, the top, bottom, second and third PCB layers together comprising electronics of the battery pack, the electronics further comprising a charging circuit coupled to the plurality of accumulator batteries, the charging separate from a main supplying power to the load. The invention also provides a power supply commutator for optimally supplying varied amounts of power the plurality of heating elements as needed; and a microcontroller for proving programmable control of the supplying varied amount of power via the power supply commutator. Also provided in the electronics is an up/down voltage converter to assist in cell balancing of the power supply.

Further to the invention in this aspect, the electronics further has instrumentation, the instrumentation for monitoring the plurality of accumulator battery cells for over temperature, charge relative to fully charged, over voltage, under voltage and under current. Also as in other invention aspects, the microcontroller has a radio transceiver for remote command and control of the battery pack.

In yet a third aspect the invention may be characterized as portable power supply comprising: a plurality of accumulator battery cells for providing power to a load via a main circuit; a corresponding up/down voltage converter for each of the plurality of accumulator battery cells to assist in cell balancing of the power supply; and a microcontroller for proving programmable control of the supplying varied amount of power via the power supply commutator, wherein each of the plurality of cells further comprises instrumentation, the instrumentation for monitoring for over temperature, charge relative to fully charged, over voltage, under voltage or under current.

The invention in the third aspect may further be characterized as having a charging circuit coupled to the plurality of accumulator batteries, the charging circuit separate from the main circuit supplying power to the load; and a power supply commutator for optimally supplying varied amounts of power to the load as needed. Additionally in this aspect, the microcontroller provides indication of a heating element temperature, the heating element temperature corresponding to a built-in heated garment device temperature, and wherein the microcontroller further provides indication for a power supply charge capacity relative to fully charged.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a perspective view of a power supply particularly suitable for providing power to heating elements;

FIG. 1B is a top aspect view of the embodiment illustrated in FIG. 1A further illustrating a curved design;

FIG. 1C provides a front plan view thereof;

FIG. 1D is an end view of the invention embodiment; and

FIG. 2 is a block diagram illustrating how power is supplied to a heating element of the present invention.

### DETAILED DESCRIPTION OF PREFERRED EMBODIMENTS

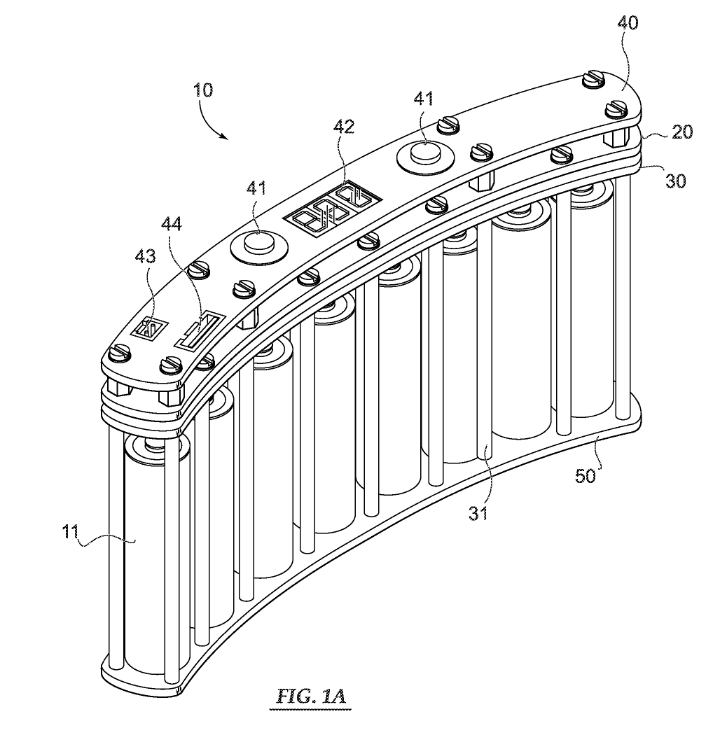

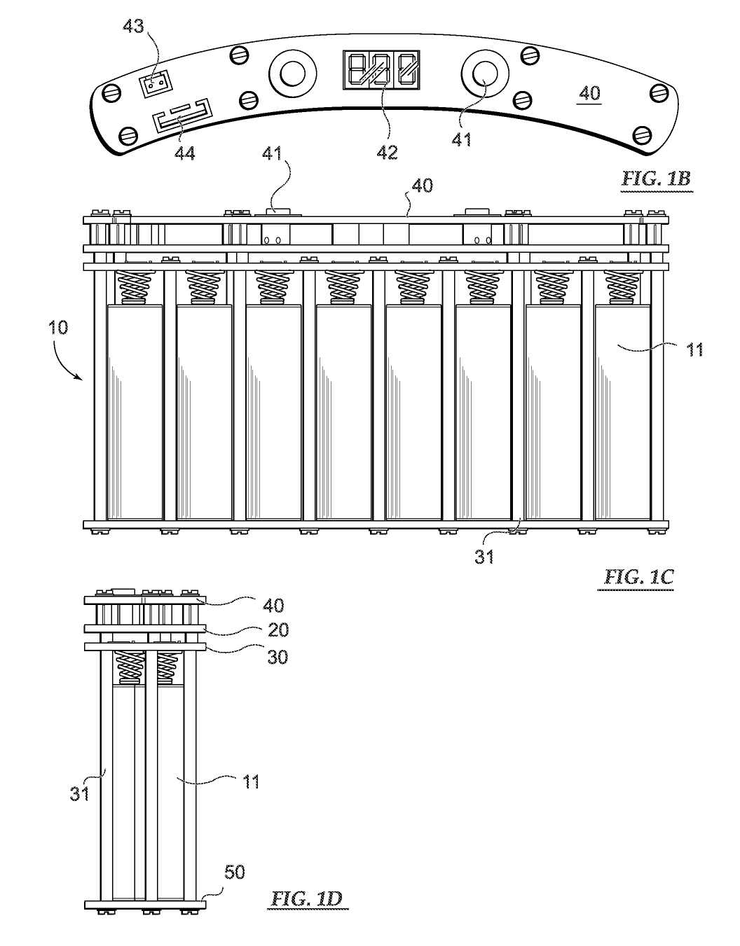

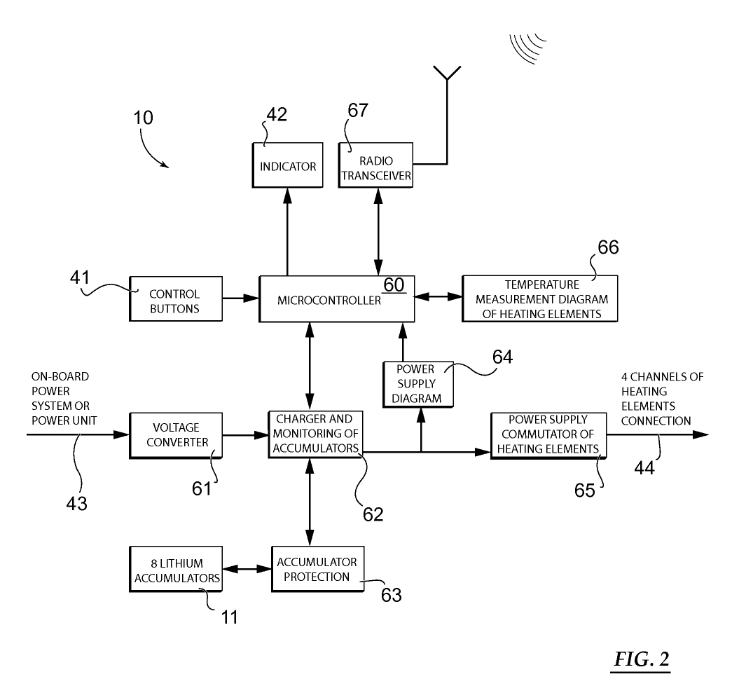

With regard to FIG. 1A, a perspective view of a bank of accumulator batteries forming a power supply 10 is illustrated. In this configuration, several printed circuit board layers 20, 30, 40, 50 form the power supply circuit also comprising electronics to achieve specific objectives of the present invention as disclosed herein. Development of the present invention 10 was motivated by a need for smaller, better, lighter-weight power sources for use by individual field operators. Importantly, the power supply 10 comprises a microcontroller 60 (FIG. 2) that provides control and monitoring 62 of accumulator characteristics and indications. In a preferred embodiment, the power supply further comprises four channels 44 coupled to four heating elements. The power supply 10 additionally comprises an antenna coupled to a transceiver 67 providing wireless control of the each individual channels 44. Also, the wireless Rf control functions reliably even underwater.

As shown and also with regard to FIG. 1B, the power supply 10 comprises a curved shape in a top aspect 40. The curved shape is designed to provide a wearable power supply to a user allowing the device to fit the body more naturally. FIG. 1C illustrates a front aspect view of the power supply device 10 comprising accumulator cells 11. In a preferred embodiment, the accumulator cells 11 are lithium ion cells 18650 type. One aspect of the present invention seeks to manage and maximize capabilities of the battery pack 10 based on the fact that no two lithium ion cells are exactly alike. Typically, the battery pack 10 is limited by its weakest cell due to restrictions in temperature, over-voltage, under charge, etc. The present invention, in a preferred embodiment will monitor 62 and switch-off 63 cells that would constrain system operability. More specifically, in an overvoltage situation, the microcontroller 60 will direct the specific cell 11 to switch off line. In an under voltage situation an Up/Down voltage converter 61 is provided to make a voltage correction.

FIG. 1D further provides an end view of the present invention 10. In addition to the curved shape in a top aspect, in invention provides a plurality of vias 31 connecting a plurality of printed circuit board layers 20, 30, 40, 50, the vias providing electrical conduction between the plurality of printed circuit board 20, 30, 40, 50 layers in addition to providing structural support to the portable power supply 10. As shown, the vias 31 are further arranged in a cage assembly with respect to the plurality of accumulator battery cells 11, the cage assembly around an outer periphery of the plurality of printed circuit board layers 20, 30, 40, 50.

As stated, the electronics of the power supply 10 further comprises an Up/Down converter 61 that ensures proper discharging and charging of uneven cells to optimize total cell 10 capacity. The Up/Down converter 61 further allows external power sources 43 with lesser output levels to charge the power supply device. The power supply further comprises a built-in charging circuit 62 that manages charging of cells from an external power source 43 such as a vehicle power supply. The charging circuit 62 also allows the device to supply power 64 while charging.

Also regarding FIG. 2, the microcontroller 60 of the present invention additionally programmed to provide pulse-width-modulation (PWM) of signals via a commutator 65 to regulate power and temperature 66 of heating cells without excess loss and inefficiency. The commutator 65 basically provides pulses with varying widths to achieve the PWM. By varying the number of pulses and widths in each power channel 44, different amounts of power can be carried to each individual channel 44, thereby providing energy efficiency by supplying only the amount of power that is needed at the present moment.

Also in the preferred embodiment, the microcontroller 60 is programmed to calculate an electrical resistance of heating elements 44 at time intervals between pulses; and based on programmed data, it can quite accurately define the temperature of each heating element. This allows a user to maintain predetermined comfort temperature automatically in each individual channel 44.

The power supply system 10 of the present invention offers significant improvements in battery life (approximately 30% longer) and longevity (more charge-discharge cycles) than in previous designs. In a preferred embodiment, the invention 10 further comprises an accurate digital display 42 of its present charge status and operational mode (e.g. charging or not charging). The present invention 10 is further specifically designed for management of heating elements 44 in thermal clothing (such as the thermal suits worn by divers), and provides for 24 hours of continuous use in extreme cold. Other applications are also contemplated, such as a long-life power supply for High Intensity Discharge (HID) weapon lights. Another application contemplated is a general purpose system for powering various electronic devices carried by the individual field operator (such as communications gear, etc.). Concepts herein could also apply to a power system for mobile computer devices (such as laptops, tablets, handheld electronics, etc.); and also to larger power systems serving higher power demands (such as machinery, vehicles, etc.).

As stated, the preferred embodiment 10 comprises four individually adjustable power currents 44. A battery display 42 provides indication of battery mode, accumulator battery charge, heating element temperature. It is additionally contemplated that the power supply unit 10 of the present invention be coupled to built-in clothes heating elements designed for: hunters and gamesman in colder climates, alpine skiers and snowboarders, drivers of snowmobiles and other vehicles with non-heated cab, rescuers, military, national guard, law enforcement, national parks service, pilots of glider aircraft, fisherman who prefer fly fishing, ice fishing etc. Also, a special wet suit modification is provided for divers.

By way of example and not by way of limitation, basic technical parameters of the power supply unit 10 are as follows: built-in batteries block (8 lithium batteries 2400 MAh in capacity with series-parallel circuit connecting, or sequentially in parallel) for power supply of heating elements of clothes (gloves, socks etc.); total capacity of battery bank is 4800 MAh, capacity of one battery 31 in a set of batteries is 2400 MAh; rated voltage is 14.8 V; integrated overvoltage, full discharge, overheating protection circuit of built-in batteries (individually for each battery); determination of battery bank total charge with 1% accuracy, indication of charge level; built-in circuit of battery bank charging by an external power unit, indication of charging process; control of power supply level (or required temperature setting) in heated equipment (maximum power supply level is 16.8 W), temperature measuring 66 and stabilization in every heating element 44 individually; microcontroller 60 control of all unit modes; operational temperature range up to −55° C.; and four (4) levels of output (1,2,3,4) which can be set accordingly by a switch and are shown on the indicator.

Further parameters for a design specific for two (2) devices, such as two (2) heating gloves and thus the output technical specs are as follows (if there will be 4 channels, or 4 devices to feed on the batteries, all characteristics will than be divided by 2):

1. 1st level—8 hours of work (4.2 watts per channel, or per heating glove).

2. 2nd level—6 hours of work (8.4 watts per channel).

3. 3rd level—4 hours (12.6 watts per channel).

4. 4th level—2 hours (16.8 watts per channel).

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Ultra Power Supply as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A portable power supply comprising:
a plurality of accumulator battery cells for providing power to a load via a main circuit;
a charging circuit coupled to the plurality of accumulator batteries, the charging circuit separate from the main circuit supplying power to the load;
a power supply commutator for optimally supplying varied amounts of power to the load as needed; and
a microcontroller for providing programmable control of the supplying varied amount of power via the power supply commutator.

2. The portable power supply of claim 1, the plurality of accumulator batteries each comprising a corresponding up/down voltage converter to assist in cell balancing of the power supply.

3. The portable power supply of claim 1, wherein the load comprises four heating elements, and wherein the plurality of accumulator battery cells comprises eight cells and wherein the power supply comprises four channels providing power to the four heating elements configured to clothing for outdoor users in colder climates.

4. The portable power supply of claim 1, wherein each of the plurality of cells comprises instrumentation, the instrumentation for monitoring for over temperature, charge relative to fully charged, over voltage, under voltage or under current.

5. The portable power supply of claim 1 wherein the microcontroller comprises a radio transceiver for remote command and control of the portable power supply.

6. The portable power supply of claim 1 further comprising a power channel wherein the power channel comprises a resistive circuit wherein the resistive circuit has a fixed resistance and a variable resistance, further wherein a total resistance varies linearly with a temperature of a heating element and wherein the temperature of the heating element can be calculated based on the variable resistance at any given time.

7. The portable power supply of claim 1 wherein the microcontroller provides indication of a heating element temperature, the heating element temperature corresponding to a built-in heated garment device temperature, and wherein the microcontroller further provides indication for a power supply charge capacity relative to fully charged.

8. The portable power supply of claim 1 further comprising:
a curved shape in a top aspect, the curved shape providing a wearable power supply for heated garments; and
a plurality of vias connecting a plurality of printed circuit board layers, the vias providing electrical conduction between the plurality of printed circuit board layers in addition to providing structural support to the portable power supply, the vias further arranged as a cage assembly with respect to the plurality of accumulator battery cells, the cage assembly around an outer periphery of the plurality of printed circuit board layers.

9. A heated garment comprising:
a plurality of heating elements configured to the garment;
a plurality of accumulator battery cells for providing power to the plurality of heating elements via a main circuit; and
a top printed circuit board (PCB) layer electrically connected to the plurality of accumulator battery cells, the top printed circuit board having a curved shape, and forming a battery pack, the battery pack comprising a curved shape in a top aspect and further configured to the garment providing a wearable power supply.

10. The heated garment of claim 9, wherein the plurality of heating elements comprises four heating elements, and wherein the plurality of accumulator battery cells comprises eight cells and wherein the power supply comprises four channels providing power to the four heating elements configured to clothing for outdoor users in colder climates.

11. The heated garment of claim 9, the battery pack further comprising:
a second PCB layer having a curved shape;
a third PCB layer having a curved shape; and
a bottom PCB layer opposite the top PCB layer, the top, bottom, second and third PCB layers together comprising electronics of the battery pack, the electronics further comprising a charging circuit coupled to the plurality of accumulator batteries, the charging separate from a main supplying power to the load.

12. The heated garment of claim 11, the electronics further comprising:
a power supply commutator for optimally supplying varied amounts of power to the plurality of heating elements as needed; and
a microcontroller for providing programmable control of the supplying varied amount of power via the power supply commutator.

13. The heated garment of claim 11, the electronics further comprising an up/down voltage converter to assist in cell balancing of the power supply.

14. The heated garment of claim 11, the electronics further comprising instrumentation, the instrumentation for monitoring the plurality of accumulator battery cells for over temperature, charge relative to fully charged, over voltage, under voltage or under current.

15. The heated garment of claim 11 further comprising a power channel wherein the power channel comprises a resistive circuit wherein the resistive circuit has a fixed resistance and a variable resistance, further wherein a total resistance varies linearly with a temperature of a heating element and wherein the temperature of the heating element can be calculated based on the variable resistance at any given time.

16. The heated garment of claim 12, the microcontroller comprising a radio transceiver for remote command and control of the battery pack.

17. A portable power supply comprising:
a plurality of accumulator battery cells for providing power to a load via a main circuit;
a corresponding up/down voltage converter for each of the plurality of accumulator battery cells to assist in cell balancing of the power supply; and
a microcontroller for providing programmable control of the supplying varied amount of power via the power supply commutator, wherein each of the plurality of cells further comprises instrumentation, the instrumentation for monitoring for over temperature, charge relative to fully charged, over voltage, under voltage or under current.

18. The portable power supply of claim 17, further comprising:
a charging circuit coupled to the plurality of accumulator batteries, the charging circuit separate from the main circuit supplying power to the load; and
a power supply commutator for optimally supplying varied amounts of power to the load as needed.

19. The portable power supply of claim 17, wherein the load comprises four heating elements, and wherein the plurality of accumulator battery cells comprises eight cells and wherein the power supply comprises four channels providing power to the four heating elements configured to clothing for outdoor users in colder climates.

20. The portable power supply of claim 17 wherein the microcontroller provides indication of a heating element temperature, the heating element temperature corresponding to a built-in heated garment device temperature, and wherein the microcontroller further provides indication for a power supply charge capacity relative to fully charged.
